(19) United States
(12) Patent Application Publication
(10) Pub. No.: US 2011/0158111 A1
(43) Pub. Date: Jun. 30, 2011

(54) BULK SERVICE PROVISIONING ON LIVE NETWORK

(75) Inventors: Denis Proulx, Kanata (CA); Reda Laichi, Ottawa (CA)

(73) Assignee: Alcatel-Lucent Canada Inc., Ottawa (CA)

(21) Appl. No.: 12/647,825

(22) Filed: Dec. 28, 2009

(51) Int. Cl. H04L 12/26; H04M 1/24; H04M 3/42

(52) U.S. Cl. 370/252; 379/26.01; 379/201.02

(57) ABSTRACT

The invention is directed to a method and system for bulk provisioning of telecommunications services on a live network and is suited to migrating telecommunications services from a legacy network to another network. Customer service data files can be imported, and validated against customer service rules and against live configuration data of the live network. Actions are logged and can be rolled back when errors are encountered.

### CROSS REFERENCE TO RELATED APPLICATIONS

The present application is related to U.S. patent application Ser. No. 12/437,191, entitled “Auto-Binding SDP RSVP LSP Tunnel” (Proulx et al.), and filed on May 7, 2009, the entire content of which is incorporated by reference into the present application.

### FIELD OF THE INVENTION

The invention is directed to packet switching communication networks, and particularly to bulk provisioning of services on such networks.

### BACKGROUND OF THE INVENTION

Telecommunications networks are upgraded periodically to accommodate growth and to replace legacy equipment. Migrating an existing network from legacy equipment to new equipment can be very labor-intensive and requires documenting all the existing customers and their services and provisioning these services on the new network. This process is typically carried out manually

Therefore, a means for providing an improved migration is highly desirable.

### SUMMARY OF THE INVENTION

One aspect of an embodiment of the present invention is directed to a method for bulk provisioning of telecommunications services onto a first network. The method comprises steps of: importing customer service data at a service platform, from a second telecommunications network; validating at a service platform, format of the customer service data; validating at a service platform, compatibility of the customer service data with the first network; provisioning customer services on the first network corresponding to the customer service data; and activating the customer services on the first network.

Some embodiments of the present invention further comprise a step of performing diagnostics on the first network.

Some embodiments of the present invention further comprise steps of logging the steps of importing, provisioning and activating.

Some embodiments of the present invention further comprise steps of rolling back one or more of the steps of activating, provisioning and importing.

In some embodiments of the present invention the step of importing customer service data comprises reading a data file.

In some embodiments of the present invention the data file is in the format of a spreadsheet file.

In some embodiments of the present invention the step of importing customer service data further comprises steps of: extracting the customer service data from said second telecommunications network via a network management entity; and storing said customer service data in said data file.

In some embodiments of the present invention the customer service data represents customer services comprising layer 2 services.

In some embodiments of the present invention the layer 2 services comprise services selected from: Virtual Leased Line (VLL) services; and Ethernet Virtual Private Network (VPN) services.

In some embodiments of the present invention the customer services comprise layer 3 services.

In some embodiments of the present invention the layer 3 services comprise services selected from: Virtual Private Routed Network (VPRN) services; and Internet Protocol-Virtual Private Network (IP-VPN) services.

Another aspect of an embodiment of the present invention is directed to a system for bulk provisioning of telecommunications services onto a first network. The system comprises: a network management entity configured to manage network nodes and services on the network; a service platform in communication with the network management entity; wherein the service platform is configured to: import customer service data at a service platform, from a second telecommunications network; validate at a service platform, format of the customer service data; validate at a service platform, compatibility of the customer service data with the first network; provision customer services on the first network corresponding to the customer service data; and activate the customer services on the first network.

In some embodiments of the present invention the service platform is further configured to perform diagnostics on the first network.

In some embodiments of the present invention the service platform is further configured to log the steps of importing, provisioning and activating.

In some embodiments of the present invention the service platform is further configured to roll back one or more of said steps of activating, provisioning and importing.

In some embodiments of the present invention the service platform is further configured to import customer service data by reading a data file.

In some embodiments of the present invention the data file is in the format of a spreadsheet file.

In some embodiments of the present invention the service platform is further configured to extract the customer service data from the second telecommunications network via a network management entity; and store the customer service data in the data file.

In some embodiments of the present invention the customer service data represents customer services selected from, Virtual Leased Line (VLL) services, Ethernet Virtual Private Network (VPN) services, Virtual Private Routed Network (VPRN) services; and Internet Protocol-Virtual Private Network (IP-VPN) services.

Another aspect of an embodiment of the present invention is directed to a program storage device readable by a machine, tangibly embodying a program of instructions executable by the machine to perform method steps described above.

### BRIEF DESCRIPTION OF THE DRAWINGS

Some embodiments of apparatus and/or methods in accordance with embodiments of the present invention are now described, by way of example only, and with reference to the accompanying drawings in which:

FIG. 1 illustrates a network configuration for bulk provisioning of services in a telecommunications network in accordance with an embodiment of the present invention;

FIG. 2 illustrates a flowchart for a method for bulk provisioning of services in a telecommunications network according to the embodiment depicted in FIG. 1; and

FIG. 3 illustrates a state diagram for bulk provisioning of services in a telecommunications network in accordance with an embodiment of the present invention.

In the figures like features are denoted by like reference characters.

### DETAILED DESCRIPTION

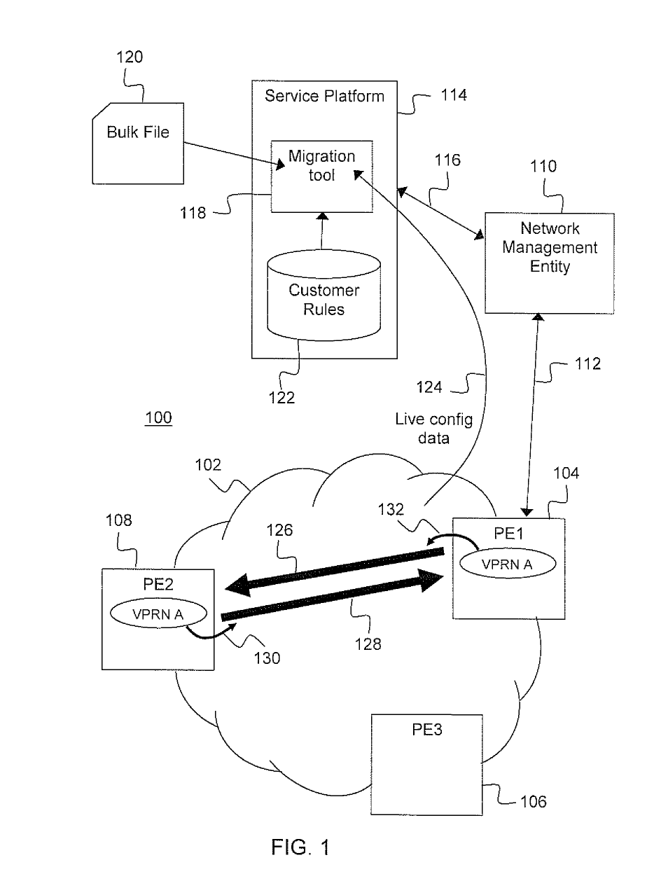

FIG. 1, illustrates a network configuration 100 for bulk provisioning of services in a telecommunications network and especially suited to bulk provisioning in the context of migrating customer services from a legacy network to a new network. Internet Protocol (IP) network 102 has network elements 104, 106, 108 providing customer services such as Virtual Private Routed Network (VPRN) “A” 130, 132 carried on transport tunnels 126, 128. Network management system 110 is communicatively coupled to the network elements in the network via communication link 112. The network management system 110 is capable of performing operation, administration and maintenance (OAM) type functions on the network elements. The network configuration 100 also includes a service platform 114 that is communicatively coupled to the network management system 110 via an open operating system (OS) interface 116. The service platform 114 executes a service application such as migration tool 118 in communication with customer rules 122 stored on the service platform 114. Other types of service applications can provide various tools for streamlining OAM tasks and diagnostic tools. The service platform 114 can also provide various user interfaces to allow access to these tools via terminals, computers, portable devices or handheld devices either directly connected or connected remotely (either wired or wirelessly) to the Network Management System 110. Using the open OS interface 116, the service platform 114 can issue OAM control commands to the network management system 110 including commands to effect provisioning changes at the network elements 104, 106, 108. Migration tool 118 is configured to read bulk file 120 which contains a list of all customer services to be provisioned on network 102. Bulk file 120 can be in the form of a spreadsheet for example a Microsoft excel .XML file. A spreadsheet is a convenient form for exporting details of customer services from a legacy network in order to migrate those customer services to new network 102. It will be understood by persons skilled in the art that other data formats for detailing and exporting customer service information would also work. Migration total 118 can extract live configuration data 124 via network management entity 110.

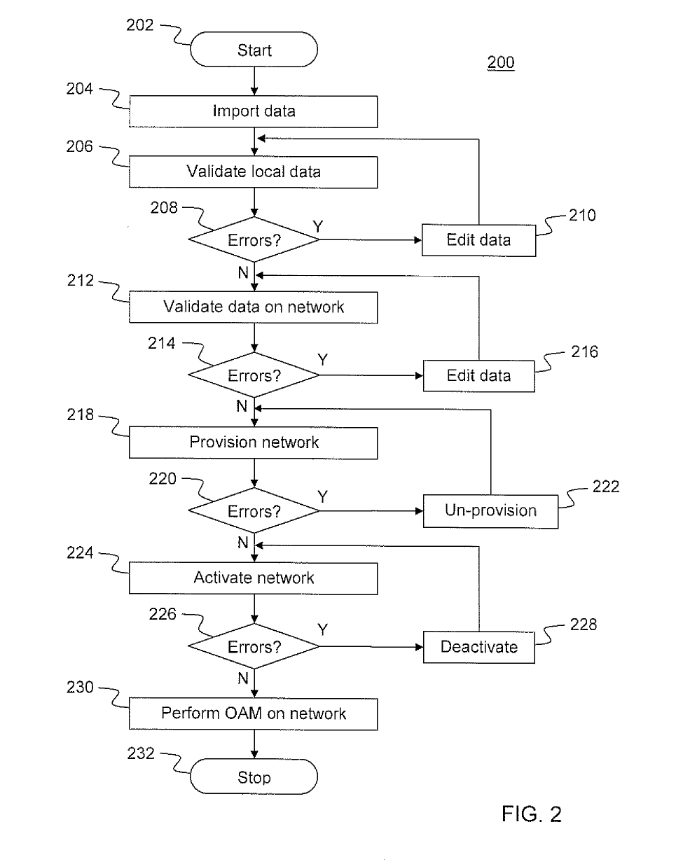

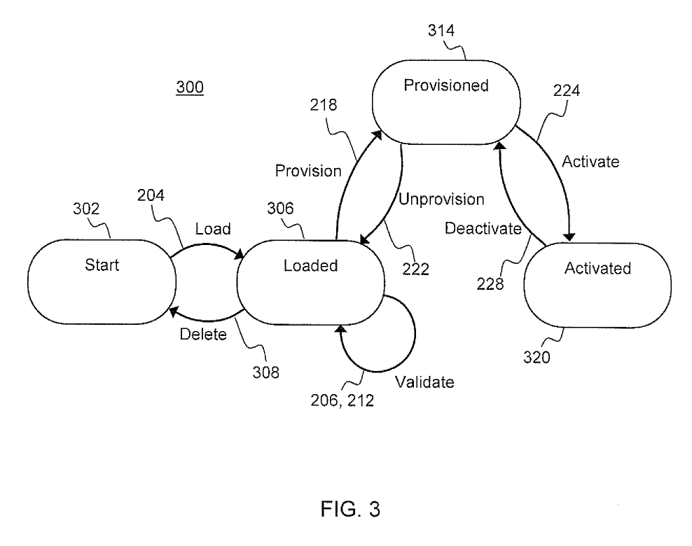

An embodiment of the process of the present invention will be described with reference to FIG. 1, FIG. 2 and FIG. 3, where FIG. 2 illustrates a flow chart of an embodiment of the process of the invention and FIG. 3 illustrates a state diagram of an embodiment of the invention. A user, typically service personnel for a telecommunications service provider, accesses a Migration tool 118 on service platform 114 and initiates the migration process. The process starts at step 202 where the system is in “Start” state 302. At step 204, the migration tool 118 imports a list of existing customer services into a database on the service platform 114, by loading bulk file 120 containing a list of all customer services to be provisioned on network 102. In some embodiments, the bulk file 120 is a Microsoft Excel spreadsheet. This system is now in “Loaded” state 306. At step 206 migration tool 118 performs a validation of the data in the bulk file to ensure that no fields are missing data and that all mandatory fields for each service are correctly populated and in the correct format. The migration tool validates parameters such as customer ID, Router IP, ingress QoS policy, source port, destination port to ensure they conform to customer rules 122 stored on the service platform 114. Thus each customer service entry is compared to the relevant customer rules.

The migration tool reports any missing parameters by reporting the name of the missing parameter, and the row and column in the bulk file.

At step 208 if the migration tool 118 reports errors then the process proceeds to step 210 to allow the user to correct errors in the bulk file at step 210. Also, modifications can be made to the bulk file such as adding additional routers or other network elements or services. The process then returns to step 206 to validate the local data again.

If there are no errors due process continues to step 212. At step 212 the migration tool 118 retrieves live configuration data 124 from network elements on the live network via the network management entity 110. The migration tool 118 is thus in synchronization with the live network. In some embodiments the live configuration data is previously stored at the network management entity 110. Migration tool 118 then performs a network data validation by comparing the local data provided in the bulk file with the live configuration data 124. The network and data validation can verify that: required network elements such as routers exist; that required ports are configured; that network nodes are accessible; that customer names are unique; that maximum transmission unit (MTU) sizes are appropriate; that appropriate Quality of Service (QoS) policies exist; etc.

At step 214 if the migration tool 118 reports errors, then the process proceeds to step 216 to allow the user two correct errors and discrepancies. The process then returns to step 212 to perform network data validation again.

If there are no errors at step 214 then the process continues to step 218. At step 218 the migration tool 118 can instruct the network management entity to 110 to provision the customer services from the bulk file 120 onto the live network 102. The system is then in “Provisioned” state 314. If errors occur during the provisioning process then at step 220 the migration tool 118 allows the user to un-provision the provisioned services at step 222.

The migration tool 118 logs all of the activities of this process to permit seamless rollback. Thus the un-provision step 222 can return the system to its previous “Loaded” state 306. Because all activities of this process are logged, a log of all actions can be displayed to the user for documentation, confirmation and for trouble shooting.

If the provisioning was determined to be successful at step 220, then the process continues to step 224 where the migration tool 118 allows the user to instruct the migration tool to activate the provisioned services on the network, after which, the system is now in “Activated” state 320. Note that typically, the activation step is performed after physical cables are connected to the live network 102, or in the case of a migration from a legacy network, after physical cables are switched over from the legacy network to the new network 102.

At step 226 for the migration tool 118 verifies that the activate step 224 was a successful. If errors are detected the migration tool 118 allows the user to roll back or deactivate the activation of the customer services at step 228, after which the process returns to step 224. This will protect against partial deployment in the network.

If the migration tool 118 determines how that if there were no errors in the activation of customer services than the process proceeds to step 230 to where the migration tool 118 allows the user to perform Operations, Administration and Maintenance (OAM) tests on the provisioned and activated customer services on network 102, to verify the performance of the network and the customer services. Examples of tests include measuring the delay, and jitter of new services in the network, and validating that they are within acceptable Service Level Agreement (SLA) specifications. The process then ends at step 232.

This system can simplify workflows and stream line laborious manual user processes for bulk provisioning of new networks or for migrating customer services from a legacy network to a new network. In this manner multiple customer services can be auto-provisioned. This system allows thousands of services to be provisioned within minutes

The migration tool also permits bulk deletion of services so that services that were misconfigured during this process or misconfigured previously, can be deleted easily.

Various customer services can be processed by embodiments of the present invention, layer 1 services such as Ethernet wireline services, layer 2 services such as Virtual Leased Line (VLL) services; and Ethernet Virtual Private Network (VPN) services, layer 3 services such as Virtual Private Routed Network (VPRN) services; and Internet Protocol Virtual Private Network (IP-VPN) services.

A person of skill in the art would readily recognize that steps of various above-described methods can be performed by programmed computers. Herein, some embodiments are also intended to cover program storage devices, e.g., digital data storage media, which are machine or computer-readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the Figures, including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the FIGS. are conceptual only. Their function may be carried out through the operation of program logic, through dedicated logic, through the interaction of program control and dedicated logic, or even manually, the particular technique being selectable by the implementer as more specifically understood from the context.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Numerous modifications, variations and adaptations may be made to the embodiment of the invention described above without departing from the scope of the invention, which is defined in the claims.

What is claimed is:

1. A method for bulk provisioning of telecommunications services onto a first network, the method comprising steps of:
importing customer service data at a service platform, from a second telecommunications network;
validating at a service platform, format of said customer service data;
validating at a service platform, compatibility of said customer service data with said first network;
provisioning customer services on said first network corresponding to said customer service data; and
activating said customer services on said first network.

2. The method of claim 1, further comprising a step of performing diagnostics on said first network.

3. The method of claim 1, further comprising steps of logging said steps of importing, provisioning and activating.

4. The method of claim 3, further comprising steps of rolling back one or more of said steps of activating, provisioning and importing.

5. The method of claim 1, wherein said step of importing customer service data comprises reading a data file.

6. The method of claim 5, wherein said data file is in the format of a spreadsheet file.

7. The method of claim 5, wherein said step of importing customer service data further comprises steps of:
extracting said customer service data from said second telecommunications network via a network management entity; and
storing said customer service data in said data file.

8. The method of claim 1, wherein said customer service data represents customer services comprising layer 2 services.

9. The method of claim 8, wherein said layer 2 services comprise services selected from: Virtual Leased Line (VLL) services; and Ethernet Virtual Private Network (VPN) services.

10. The method of claim 9, wherein said customer services comprise layer 3 services.

11. The method of claim 10, wherein said layer 3 services comprise services selected from: Virtual Private Routed Network (VPRN) services; and Internet Protocol-Virtual Private Network (IP-VPN) services.

12. A system for bulk provisioning of telecommunications services onto a first network, the system comprising:
a network management entity configured to manage network nodes and services on said network;
a service platform in communication with said network management entity;
wherein said service platform is configured to:
import customer service data at a service platform, from a second telecommunications network;
validate at a service platform, format of said customer service data;
validate at a service platform, compatibility of said customer service data with said first network;
provision customer services on said first network corresponding to said customer service data; and
activate said customer services on said first network.

13. The system of claim 12 wherein said service platform is further configured to perform diagnostics on said first network.

14. The system of claim 12 wherein said service platform is further configured to log said steps of importing, provisioning and activating.

15. The system of claim 14 wherein said service platform is further configured to roll back one or more of said steps of activating, provisioning and importing.

16. The system of claim 12 wherein said service platform is further configured to import customer service data by reading a data file.

17. The system of claim 12 wherein said data file is in the format of a spreadsheet file.

18. The system of claim 12 wherein said service platform is further configured to extract said customer service data from said second telecommunications network via a network management entity; and store said customer service data in said data file.

19. The system of claim 12 wherein said customer service data represents customer services selected from, Virtual Leased Line (VLL) services, Ethernet Virtual Private Network (VPN) services, Virtual Private Routed Network (VPRN) services; and Internet Protocol-Virtual Private Network (IP-VPN) services.

20. A program storage device readable by a machine, tangibly embodying a program of instructions executable by the machine to perform method steps of claim 1.
